(19) United States
(12) Patent Application Publication
(10) Pub. No.: US 2014/0328949 A1
(43) Pub. Date: Nov. 6, 2014

(54) ELECTROCHEMICALLY GENERATED ANTIMICROBIAL SODIUM HYDROXIDE SOLUTION

(71) Applicant: AQUAOX, INC., Fontana, CA (US)

(72) Inventors: Phillip Adams, Roswell, GA (US); Michel van Schaik, Loxahatchee, FL (US)

(73) Assignee: Aquaox, Inc., Fontana, CA (US)

(21) Appl. No.: 13/888,092

(22) Filed: May 6, 2013

(51) Int. Cl. A01N 59/00; B08B 6/00

(52) U.S. Cl. CPC A01N 59/00; B08B 6/00
USPC 424/722; 134/6

(57) ABSTRACT

The present invention provides a method for generating an Enhanced Electrolyzed Alkaline Water solution or hydrogel formulation containing a pH of approximately 12.5 and a Sodium Hydroxide concentration between 150 and 200 ppm having excellent sanitizing and disinfecting properties. The invention further provides methods to apply the Sodium Hydroxide solution as hard surface sanitizer and as a fogging medium for sanitizing stables, barns including poultry incubators as replacement of nowadays used chemical cleaning agents or in case of fumigation replacement of formaldehyde. Finally, the invention discloses usage of modified Enhanced Electrolyzed Water formulations for use as topical treatment in veterinary applications for livestock and wherein gelling-agents, dyes, fragrances, foaming agents, biocides, biopesticides may be blended into the Enhanced Alkaline Water to address specific bactericidal or fungal diseases.

### RELATED APPLICATIONS

The present invention is related to U.S. patent application Ser. No. 13/718,677, filed Dec. 18, 2012, and entitled “APPARATUS AND METHOD FOR GENERATING A STABILIZED SANITIZING SOLUTION”; U.S. patent application Ser. No. 13/718,721, filed Dec. 18, 2012, and entitled “MESH ELECTRODE ELECTROLYSIS APPARATUS AND METHOD FOR GENERATING A SANITIZING SOLUTION”; and U.S. patent application Ser. No. 13/324,714, filed Dec. 13, 2011, entitled “DUAL DIAPHRAGM ELECTROLYSIS CELL ASSEMBLY AND METHOD FOR GENERATING A CLEANING SOLUTION WITHOUT ANY SALT RESIDUES AND SIMULTANEOUSLY GENERATING A SANITIZING SOLUTION HAVING A PREDETERMINED LEVEL OF AVAILABLE FREE CHLORINE AND pH”; U.S. patent application Ser. No. 13/887,147, filed May 3, 2013, and entitled “METHOD FOR STABILIZING AN ELECTROCHEMICALLY GENERATED SANITIZING SOLUTION HAVING A PREDETERMINDED LEVEL OF FREE AVAILABLE CHLORINE AND pH”, the contents of the above referenced applications are incorporated herein by reference in its entirety.

### FIELD OF THE INVENTION

The present invention relates to stabilized solutions and formulations of disinfectants, sanitizing solutions and all-purpose antimicrobial surface cleaners.

### BACKGROUND OF THE INVENTION

Cleaning is essential to protecting health in homes, schools and workplaces. However, household and cleaning products, including soaps, polishes and grooming supplies, often include harmful chemicals. Even products advertised as “green” or “natural” may contain ingredients that can cause health problems. Some cleaning supplies can be flammable or corrosive. Many cleaning agents can irritate the eyes or the throat or cause headaches or other health problems. Some products release dangerous chemicals, including volatile organic compounds (VOCs). Other harmful ingredients include ammonia and bleach. Even natural fragrances such as citrus can react to produce dangerous pollutants indoors. VOCs and other chemicals released when using cleaning supplies contribute to chronic respiratory problems, allergic reactions and headaches, Studies are underway to assess how these chemicals affect people who have asthma and other respiratory illnesses. However, studies link exposure to chemicals from cleaning supplies to occupational asthma and other respiratory illnesses.

Hard Surface Sanitizers and Disinfectant leave residue that microorganisms over time can build immunity and lose efficacy. Hard Surface Sanitizers and Disinfectants are typically toxic or corrosive chemicals and have a safety risk to the user and in the case of Veterinary Applications to livestock. Hard Surface Sanitizers and Disinfectants that claim to be “green chemistry” are not always effective and have no effect on biofilms.

Antimicrobial and fungicidal Animal Applications for topical treatments are usually iodine based which is a restricted chemical, there are only a few suppliers and it is very costly. Antibacterial Animal Applications for topical treatments such as umbilical cord dips for newborn livestock, hairy foot wart on dairy cows and cattle. Fungicidal Animal Applications for topical treatments such as ringworm on livestock

Antimicrobial fogging within poultry incubators typical use formaldehyde as a disinfectant. Formaldehyde is toxic and has a severe safety risk to the poultry work. Antimicrobial fogging alternatives to formaldehyde have proven very corrosive and damaging to the hatcheries equipment.

### SUMMARY OF THE INVENTION

The present invention relates to stabilized solutions and formulations of disinfectants, sanitizing solutions and all-purpose antimicrobial surface cleaners, such as Enhanced Alkaline Water, as well as methods for their production and usage. Enhanced Alkaline Water is applicable and beneficial for cleaning, sanitizing and disinfecting hard surfaces, skin and tissue of Humans and Animals. Enhanced Alkaline Water further finds use in the prevention and treatment of fungal and bactericidal livestock diseases.

In order to enhance the cleaning or surface treatment efficacy, Alkaline Water is known to be used. U.S. Pat. Nos. 7,374,645; 7,691,249; 7,828,942; and 8,002,955, disclose the use of electrolysis cells and a process that makes it difficult to produce these enhanced alkaline solutions.

The electrolysis cell as described in U.S. Provisional application Ser. No. 13/324,714 is designed to resolve the problem with ordinary alkaline water mentioned above as well the Methods described in U.S. Provisional application Ser. No. 13/718,677 and U.S. Provisional application Ser. No. 13/718,721 utilizing 2 or more electrolysis cells generate a stable more reductive and more alkaline solution.

The cleaning solution or Alkaline Water generated from the instant invention contains no or almost no salt residues. Presence of salt residues in the Alkaline Water limits its usage for surface treatment, as salt is corrosive, streaks the surface and leaves deposits on the surface. As a result most cleaning procedures have to include an extra rinse with potable water.

This invention utilizing electrolysis cells having ionic membranes instead of ceramic diaphragms resolves the deposits of salt and thus allows for cleaning and sanitation of surfaces without additional rinsing. The Alkaline Water generated is highly stable and has the following physical properties: pH (12.5+/1.5), ORP (−400 to −800 millivolts), OH-alkalinity of 350 to 400 ppm and can be a clear solution or a hydrogel, gel, cream, paste or foam and wherein additives are used to formulate a variety of products with any loss of stability or efficacy against fungi, bacteria and microorganism.

Enhanced Alkaline Water out performs cleaners and detergents by removing more dirt, using less water and drying faster. Enhanced Alkaline Water is a completely new cleaning solution; Instead of adding dirt-removing ingredients to water followed with a rinse or sanitizer, Enhanced Alkaline Water is not only a cleaner, but a sanitizer too due to its antimicrobial and fungicidal properties. Moreover, due to its negative charge, it has an antistatic function on physical surfaces after cleaning. This helps prevent dirt from re-sticking after cleaning and sanitizing to the surface.

Typically, neat (undiluted) Enhanced Alkaline Water solutions are used for cleaning and sanitizing surfaces, as an colorless and odorless liquid product that is best sprayed, electrostatic sprayed/fogged or fumigated on the surface to be cleaned and sanitized. Because the Enhanced Alkaline Water is extremely stable, additives such as dyes, fragrances, gelling agents, foaming agents, etc. can be added to the liquid without any negative effect on its cleaning or sanitation properties. This is completely new for the industry. All other alkaline water products lose important properties, either its pH, ORP when additives are mixed.

Enhanced Alkaline water is safe for the skin, can be used for cleaning in the vicinity of people with allergies, babies, elderly and infirmed patients. Enhanced Alkaline Water applied on surfaces as a multi-purpose cleaner and sanitizer eliminate the need to store many different cleaning products.

Accordingly, it is an objective of the instant invention to disclose a process for making a cleaning solution or Alkaline Water that contains no or almost no salt residues.

It is a further objective of the instant invention to disclose the use of electrolysis cells having ionic membranes to allow for cleaning and sanitation of surfaces without additional rinsing.

It is yet another objective of the instant invention to disclose a process for making stable alkaline water that can be a clear solution or a hydrogel, gel, cream, paste or foam and wherein additives are used to formulate a variety of products with any loss of stability or efficacy against fungi, bacteria and microorganism.

It is yet another objective of the instant invention to provide enhanced Alkaline Water of a negative charge to provide an antistatic function on physical surfaces after cleaning.

Still another objective of the instant invention to provide an enhanced Alkaline Water solution that is stable allowing additives such as dyes, fragrances, gelling agents, foaming agents, and the like to be added to the liquid without any negative effect on its cleaning or sanitation properties.

It is a still further objective of the invention to provide an enhanced Alkaline Water that is safe for the skin and can be used for cleaning in the vicinity of people with allergies, babies, elderly and infirmed patients.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

The patent or application contains at least one drawing executed in color. Copies of this patent or patent application publication with color drawings will be provided by the Office upon request and payment of necessary fee.

FIG. 1 is a chart of a study illustrating the efficacy of the Enhanced Alkaline Water against pseudomonas aeruginosa based on contact time;

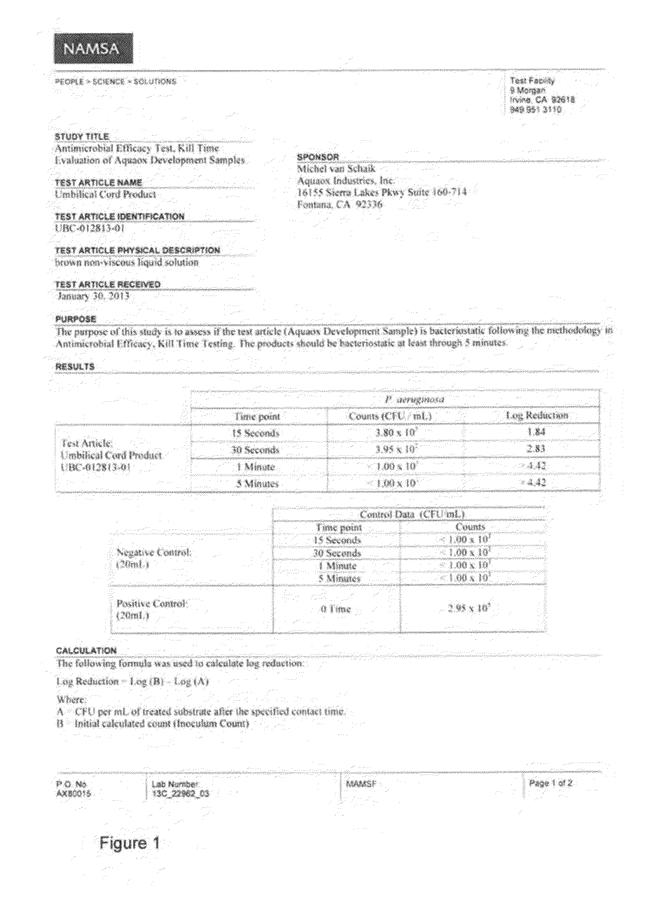

FIG. 2 is a pictorial illustrating the unique physical characteristics of Enhanced Alkaline Water's hydrophilic and hydrophobic property;

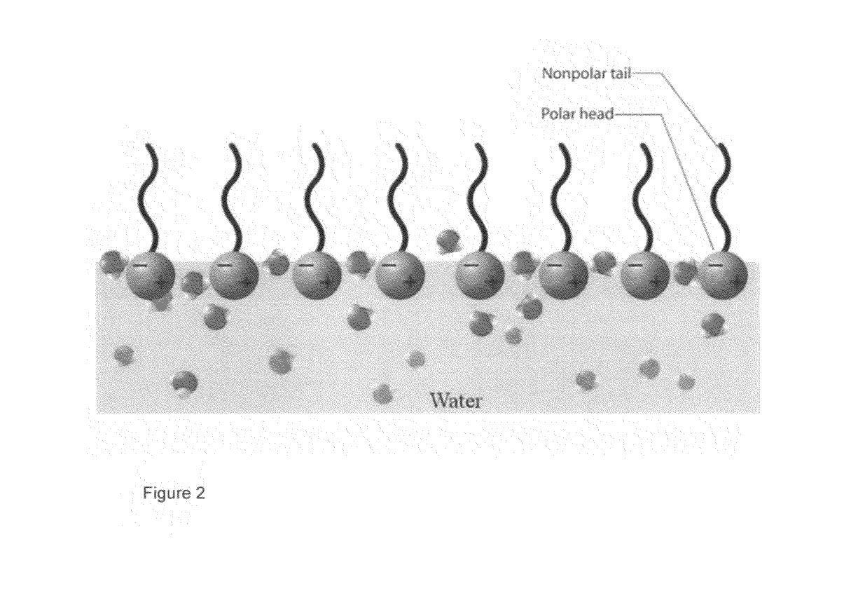

FIG. 3 is a pictorial illustrating the unique physical characteristic of Enhanced Alkaline Water's emulsification property;

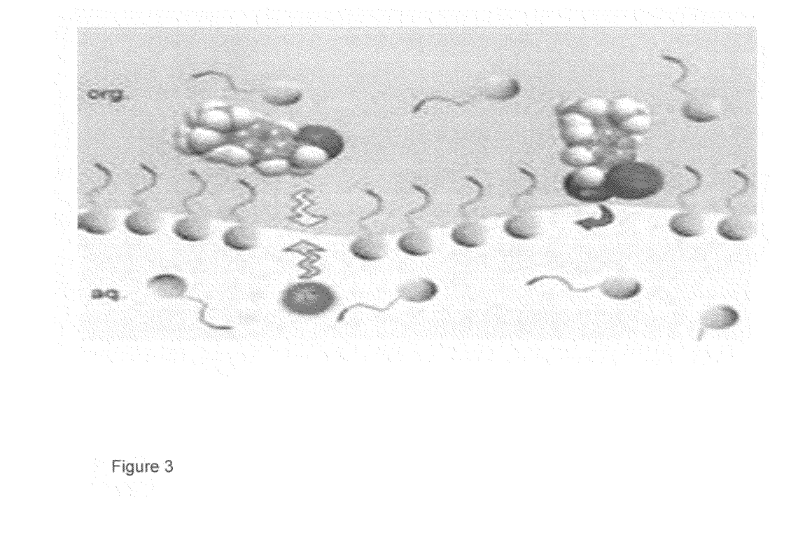

FIG. 4 is a study provide by three sample names illustrating the efficacy of a modified Enhanced Alkaline Water formulation against E. coli O157:H7, S. typhimurium, and P. aeruginosa based on 30 seconds contact time Enhanced Alkaline Water;

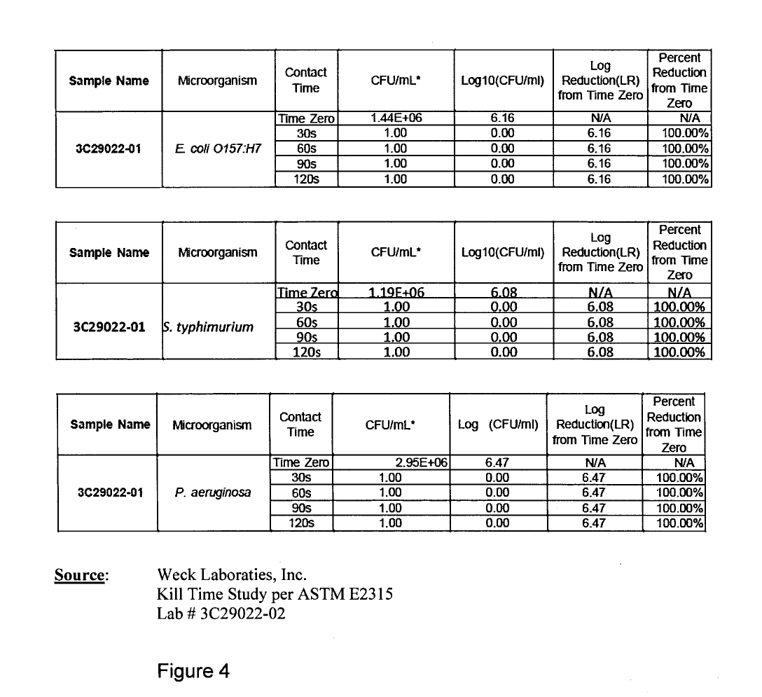

FIG. 5 is piglet comparison of enhanced alkaline water versus 7% iodine measured at 0 hours past base;

FIG. 6 is piglet comparison of enhanced alkaline water versus 7% iodine measured at 1 hour past base;

FIG. 7 is piglet comparison of enhanced alkaline water versus 7% iodine measured at 2 hours past base;

FIG. 8 is piglet comparison of enhanced alkaline water versus 7% iodine measured at 4 hours past base;

FIG. 9 is piglet comparison of enhanced alkaline water versus 7% iodine measured at 5 hours past base;

FIG. 10 is piglet comparison of enhanced alkaline water versus 7% iodine measured at 6 hours past base;

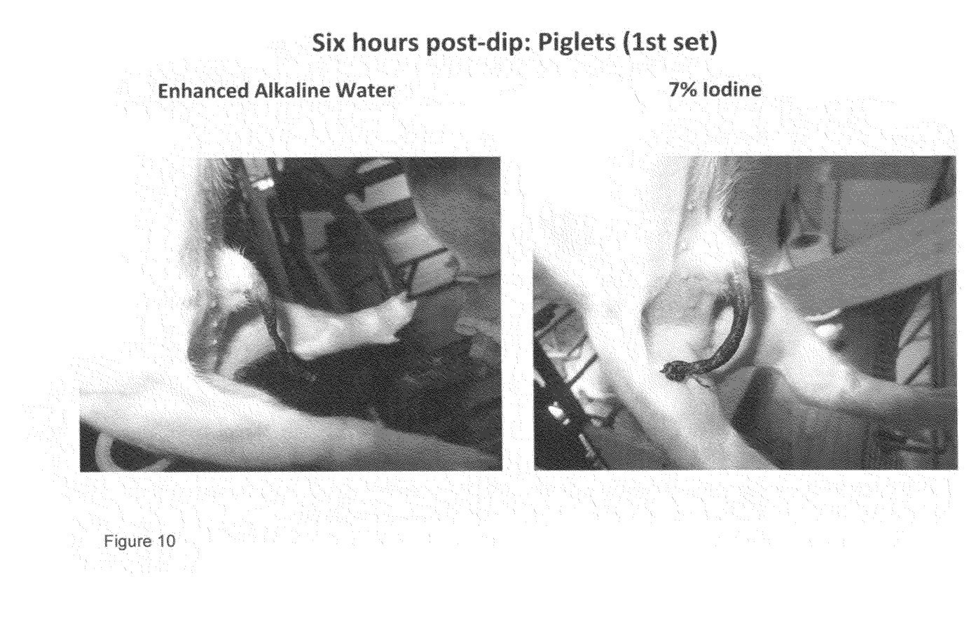

FIG. 11 is piglet comparison of enhanced alkaline water versus 7% iodine measured at 7 hours past base;

FIG. 12 is piglet comparison of enhanced alkaline water versus 7% iodine measured at 8 hours past base;

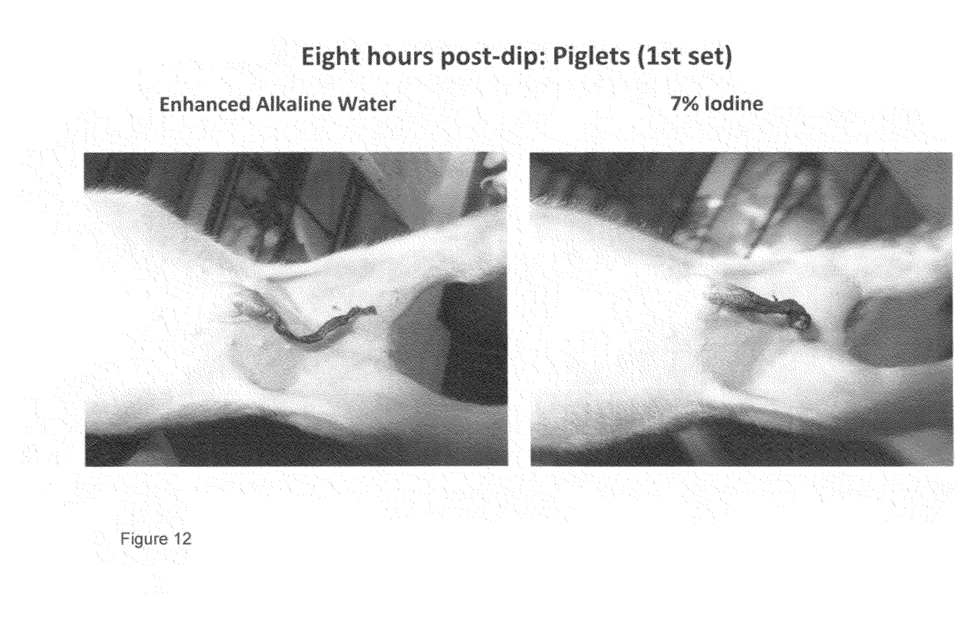

FIG. 13 is the summary of a study verifying the toxicity of a boosted Enhanced Alkaline Water formulation; and,

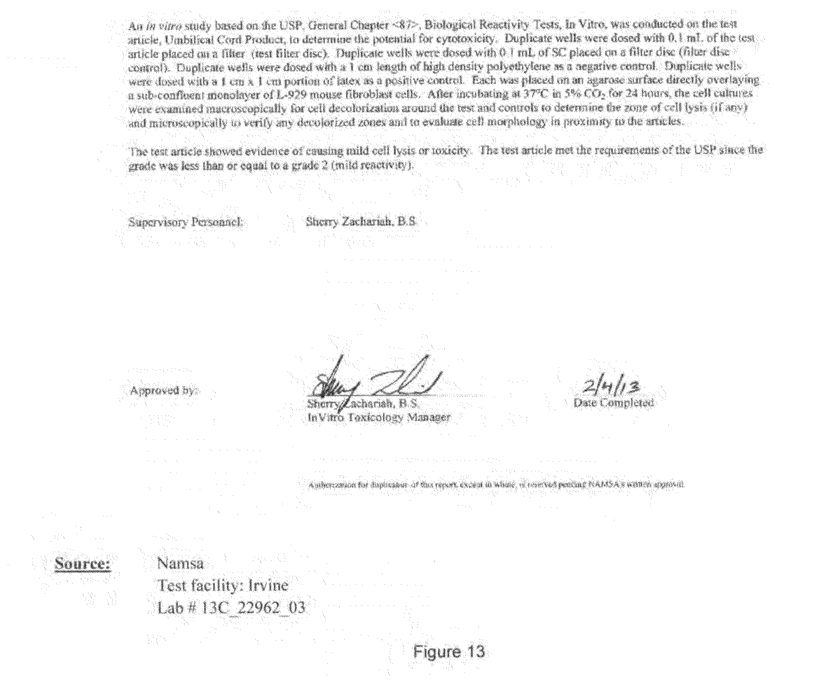

FIG. 14 is a chart depicting the umbilical cord dry-out using alkaline water versus iodine.

### DETAILED DESCRIPTION OF THE INVENTION

The present invention is directed to the generation and usage of Enhanced Alkaline Water solutions or hydrogel formulations. Water treated through Reverse Osmosis and Activated Carbon systems are combined with a brine solution and then electrolyzed through one or more electrolysis cells as described in U.S. patent application Ser. Nos. 13/324,714; 13/718,677; and Ser. No. 13/718,721, the contents of which are incorporated herein by reference. Within the electrolysis cell, positive ions are separated from the negative ions making two distinct liquids. The positives ions form Acidic Water with a concentration of 50 to 500 ppm hypochlorous acid and the negative ions form Alkaline Water with a concentration of 150 to 200 ppm of sodium hydroxide. This Enhanced Alkaline Water is boosted with alkalinity giving it specific properties for surfactancy, emulsification, degreasing, drying and for killing fungi and bacteria (microorganisms). Utilizing electrolysis cells and methods as described in the applications mentioned above, almost a 99% conversion of salt is achieved with as result that the Alkaline Water contains no or minimal amounts of any residual salt or impurity.

The Enhanced Alkaline Water of this invention has of pH 12.5+/−1.5 and an ORP (oxidation-reduction potential ranging between −400 and −800 millivolts) and an OH— alkalinity of 350 to 400 ppm as calcium carbonate. Further, Enhanced Alkaline has very strong hypertonic properties that enable to draws out moisture through the cytoplasmic membrane of microorganism, dehydrating it, stopping its cell function and quickly killing the microorganism. This together with the improved salt conversion makes the cleaning power of Enhanced Alkaline Water equivalent to a 2% sodium hydroxide solution. In addition Enhanced Alkaline Water solutions or hydrogel formulations maintain its pH, ORP and hypertonic properties for more than 1 year.

As the Enhanced Alkaline Water containing a diluted Sodium Hydroxide solution as active ingredient is more alkaline, contains no salt residues and, the solution can be used to clean any surface without rinsing the surface afterwards with distilled, RO water or tap water. This process results in a safe, non-toxic liquid with antibacterial properties. Enhanced Alkaline Water is designed as a hard surface cleaner and sanitizer. Electrostatic fogging or fumigation is an effectively method to sanitize surfaces, equipment and areas and in line with various sanitizing procedures as set by regulatory agencies such as FDA, EPA, USDA and CDC.

Enhanced Alkaline Water can also formulated to produce non-toxic, safe, topical veterinary products such as umbilical cord dips, hairy foot wart disease, treatment of ringworm, etc. by boosting its alkalinity by addition of e.g. Sodium Hydroxide, Sodium Phosphate and/or Sodium Bicarbonate. Special formulated products proved to be effective against all gram negative bacteria, E-Coli, Salmonella Typhi, Staphylococcus aureaus, and Pseudomonas aeruginosa. In addition Enhanced Alkaline Water shows efficacy against gram-positive bacteria such as MRSA (methicillin resistant staphylococcus aureaus), C. diff (clostridium difficle), VRE (vancomycin resistant enterococci) and acinetobactor baumannii.

Use of Alkaline Water operates as a Hard Surface Sanitizer and Disinfectant. The enhanced Alkaline Water dissolves and emulsifies protein, fats and oils. It can be best applied on surfaces by (electrostatic) spraying or mopping Enhanced Alkaline Water on surface to be cleaned or sanitized. Leave Enhanced Alkaline Water in contact for 5-30 seconds then wipe or rinse the surface dry with a clean cloth.

As cleaner or sanitizer, Enhanced Alkaline Water is appropriate for glass, mirrors, walls, electrical instruments, toilets and bathrooms, carpets, floors, plastic, metals, rubber. It can be used to clean floors and toilets, and it can also be used to wash and disinfect kitchens and all other conditions where rinsing is not desirable or possible.

The Enhanced Alkaline Water can be used as a Veterinary Treatment for Livestock. Umbilical Cord treatment: Navel infections in pre-weaned calves have been reported to consistently result in a mortality rate of 2% according to the National Animal Health Monitoring Service. Reduction of navel infections through appropriate management including navel dipping is beneficial to the calf and the producer and is reported to decrease navel infection rates from 20-28% to 5-14%. Obviously, navel dipping is of great importance but being able to obtain tincture of iodine has become problematic, as it became a controlled substance. It has become necessary to develop other products that can be utilized to dry the umbilicus and assist in the prevention of navel infections. Enhanced Alkaline Water is boosted with Sodium Hydroxide and Sodium Bicarbonate to create a non-flammable, non-toxic, easy to use umbilical cord product with excellent antimicrobial properties and quick dry down properties. A red-brown indication dye is added to the formulation for staining power. Enhanced Alkaline Water is sprayed on the infected or target area of the animal or the infected or target area of the animal is dipped in Enhanced Alkaline Water. Keep in contract with the area at least for 30 seconds for maximum benefit.

A study was conducted to evaluate the Enhanced Alkaline Water in Jersey and Holstein dairy calves with a range of Immunoglobulin protein levels (IgG). All calves were dipped with the Enhance Alkaline Water once shortly after calving. All calves, heifers and bulls, had a completely dried umbilical cord within 36 hours following dipping of the umbilical cord with Enhanced Alkaline Water. The umbilical stumps of all calves had no signs of infection, edema or discharge even in the calves having low total protein (less than 5.5 g/dL) and sodium sulfate turbidity test comparable to 500 mg/dL of IgG indicative of partial failure of passive transfer. The range of total protein was 4.5 to 7.0 g/dL with an average of 6.0625 g/dL with 43.75% of the calves having a total protein of less than 5.5 g/dL. Furthermore, there was no evidence of dermal irritation around the skin surrounding the umbilicus or any other area that may have contacted Enhanced Alkaline Water. There was no report of skin irritation and it is a competitive navel dip even in calves with partial failure of passive transfer. Additionally, although comparative studies are indicated, Enhanced Alkaline Water proves to be an excellent alternative to tincture of iodine.

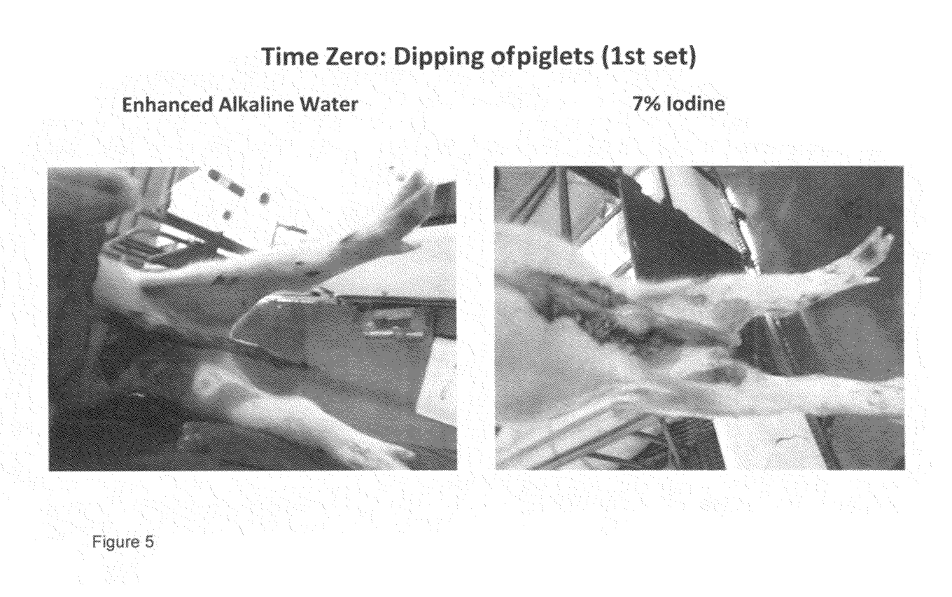

Another study was conducted to compare the dry time of Enhance Alkaline Water with 7% Iodine on piglets. FIG. 5 to show time lapse documentation and photos of umbilical cord dipped in Enhanced Alkaline Water and in 7% Iodine. Enhanced Alkaline Water is most appropriate as a Navel Dip for newborn livestock. The Enhanced Alkaline Water has proven to be effect and drying the umbilical cord 2 to 3 times faster than 7% Iodine as well as minimizing the potential risk of infection and mortality in these newborn animals.

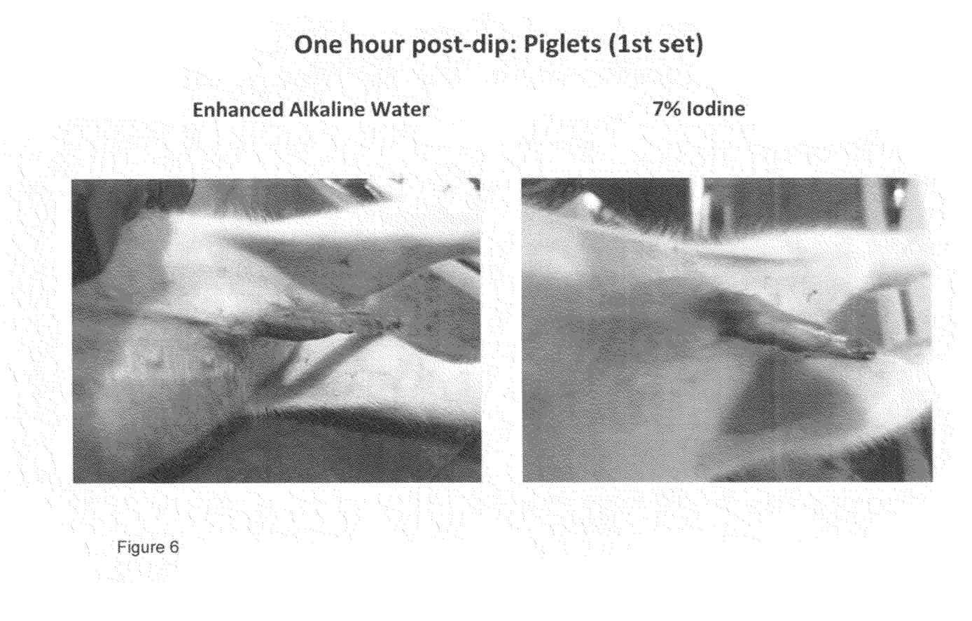

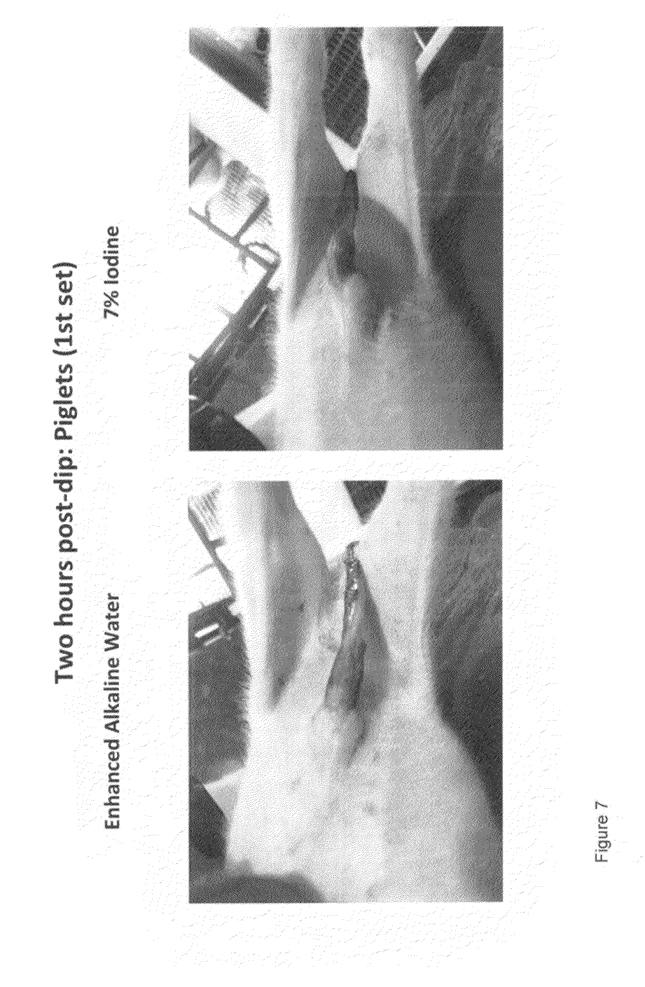

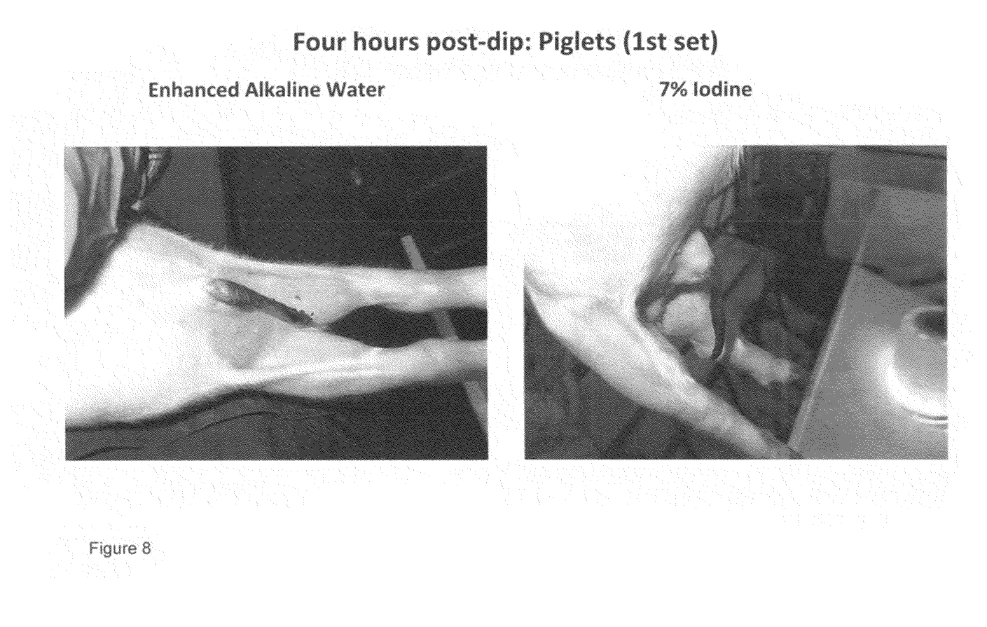

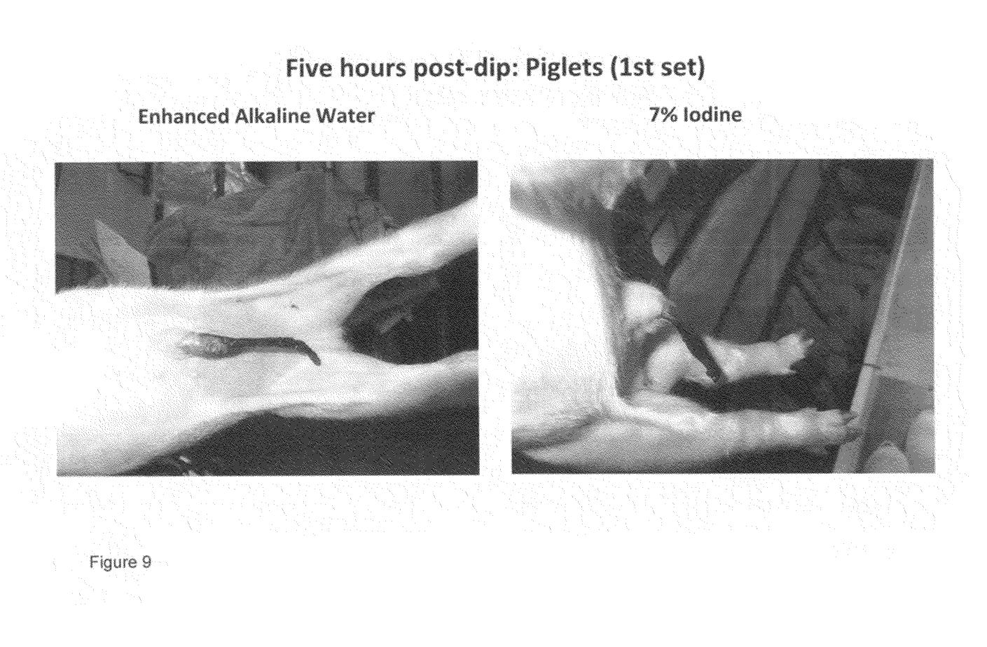

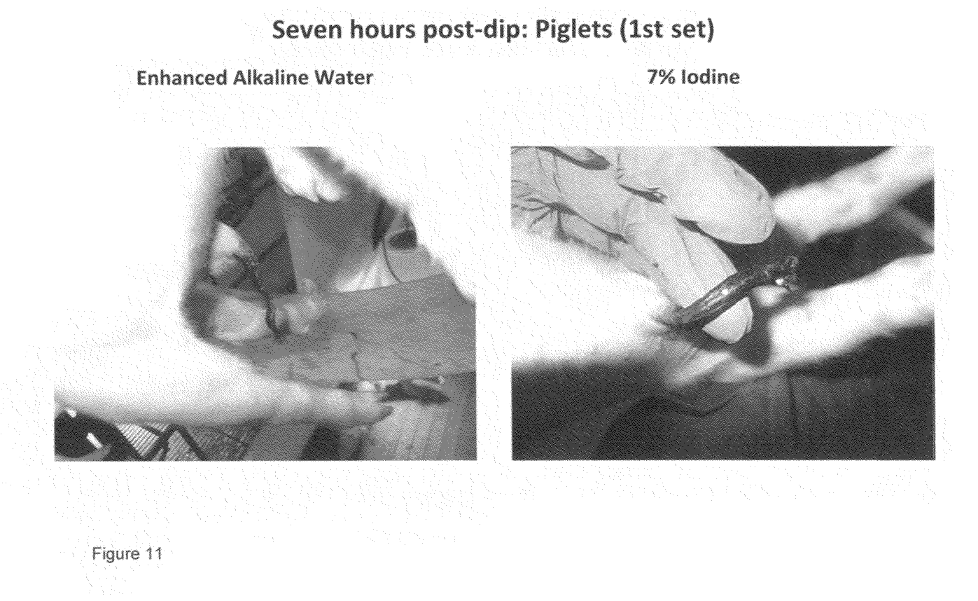

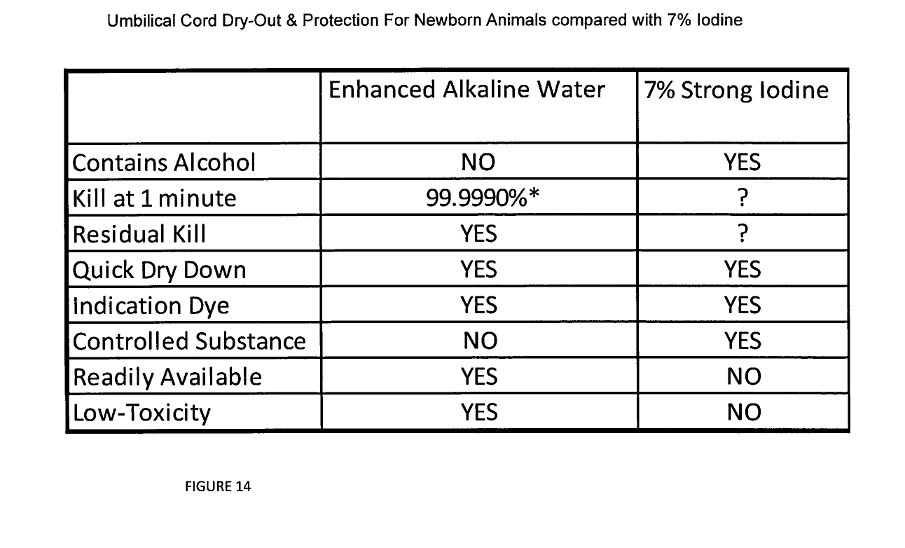

FIG. 5 is piglet comparison of enhanced alkaline water versus 7% iodine measured at 0 hours past base; FIG. 6 is piglet comparison of enhanced alkaline water versus 7% iodine measured at 1 hour past base; FIG. 7 is piglet comparison of enhanced alkaline water versus 7% iodine measured at 2 hours past base; FIG. 8 is piglet comparison of enhanced alkaline water versus 7% iodine measured at 4 hours past base; FIG. 9 is piglet comparison of enhanced alkaline water versus 7% iodine measured at 5 hours past base; FIG. 9 is piglet comparison of enhanced alkaline water versus 7% iodine measured at 6 hours past base; FIG. 11 is piglet comparison of enhanced alkaline water versus 7% iodine measured at 7 hours past base; and Figure is piglet comparison of enhanced alkaline water versus 7% iodine measured at 8 hours past base. FIG. 14 is a chart depicting the umbilical cord dry-out using alkaline water versus iodine.

Papillomatus Digital Dermatitis: Hairy foot warts were first reported in the United States more than 23 years ago and have since spread rapidly, becoming a major management concern for dairy producers both in the U.S. and in other parts of the world. Between 1991 and 1994, the frequency of infection on California dairies increased from 31% to 89%. In addition to being extremely contagious, hairy foot warts are also a very expensive problem. It is estimated that hairy foot warts cause 20% of all dairy lameness cases, with each incidence of lameness costing $90 to $130. In addition to milk loss, which ranges from 20 to 50% in affected cows, hairy foot warts often lead to reproductive problems and premature cow culling. A study of cows sent to U.S. slaughter-houses revealed that nearly 30% of cows tested had hairy foot warts on the left hind hoof.

Contrary to what the name implies hairy foot warts are not warts at all. Viruses cause warts; bacteria cause hairy foot warts. The exact causative agent is not known, but evidence suggests that one or more species of spirochete of the genus Treponema is responsible. Treponema bacteria can be anaerobic or microaerophilic and can be parasitic to humans and to animals causing a range of diseases.

Currently, the most effective treatment is the use of topical broad-spectrum antibiotics; however, treatment of hairy foot warts with antibiotics is off label so a veterinarian needs to be consulted before use. In addition, topical application of antibiotics is labor intensive and may not be practical in a large herd situation. One alternative to topical antibiotics is medicated footbaths. Advantages to the use of footbaths are that mass treatment can be achieved with little direct labor input. Since at any given time approximately 14% of cattle with hairy foot wart lesions will not be lame, treatment of all cattle may reduce future instances of the problem. Although less labor intensive than topical applications, footbaths must be properly managed. Non-antibiotic footbaths usually contain disinfectants of one kind or another, but large amounts of organic matter (manure and dirt) inactivate disinfectants and antibiotics. The biggest drawbacks to footbaths are cost and the lack of reliable efficacy data for some treatment methods. The following are some commonly employed footbaths with their advantages and disadvantages.

Antibiotics: These are a popular and effective treatment for hairy foot warts. Several research trials have shown the efficacy of tetracycline and oxytetracycline footbaths. Lincomycin may also be used, but care must be taken be-cause it is toxic to rumen microbes and should not be ingested by cattle. Hairy foot warts may become resistant to treatment with antibiotics over time.

Copper sulfate (CuSO4) Have been widely used for a number of years. Despite its use throughout the industry, copper sulfate is not an effective treatment for hairy foot warts. In addition, this compound has recently begun to cause environmental concern about Cu build-up, especially on large dairies and in acidic soils. Use of copper sulfate anywhere on the dairy is discouraged.

Zinc sulfate (ZnSO4): Limited clinical data exists on its efficacy. A 1990 study reported that 3× footbaths were effective at controlling the spread of hairy foot warts and treating mild lesions, but ineffective against more serious lesions.

Formalin (39% formaldehyde): Several studies have reported that 5% formalin treatment is effective in controlling hairy foot wart outbreaks. Formalin has a wide range of antibiotic activity, it is non-corrosive, it is biodegradable, and use of formalin is not regulated by the Federal Pasteurized Milk Ordinance. However, Formalin will not penetrate organic matter so hooves must be cleaned if they are muddy or manure packed. In addition, application of formalin to the lesion can be painful. Perhaps formalin's biggest drawback is toxicity, which can pose a health hazard to employees as well as a risk of contamination of meat or milk. If formalin is to be used for the treatment and control of foot warts, workers should be aware of its hazards and take steps to protect themselves.

Peroxides: Peroxides disrupt the cellular mechanisms of anaerobic bacteria. However, in high concentrations peroxides are very damaging to all cells. Products such as hydrogen peroxides are not stable and quickly lose their effectiveness when exposed to air or organic matter.

Because of the problems associated with footbaths and topical treatments, the industry is seeking a better solution. Enhanced Alkaline Water boosted with e.g. Sodium Hydroxide and Sodium Bicarbonate can be formulated to create a non-flammable, non-toxic, easy to use hairy foot wart product with bactericidal properties. An indication dye may be added to the formulation to give the product staining power. Enhanced Alkaline Water is appropriate for many bacterial and fungal livestock diseases such as hairy foot warts. With this bacterial disease and other skin or hoof diseases, the Enhanced Alkaline Water can be applied in footbaths.

Dermatophytosis: Ringworm is caused by infection of the hair and surface layers of the skin by fungi. It occurs in all species of animals including man. Fungal infections cause little, if any, permanent damage or economic loss. However, because ringworm is a transmissible infectious disease, animals with lesions are barred from exhibitions or shows by regulations of the State Board of Animal Health.

Infection of the skin and hair of cattle is most frequently due to Trichophyton verrucosum, a spore forming fungi. Spores are shed from the lesion by broken hairs or scabs from the lesion. The spores remain alive for years in a dry environment; and because they do, halters, grooming equipment, or even a barn can remain infective for years.

Transmission is caused by direct contact with infected animals, particularly with cattle confined to a barn, is a common method of spreading the fungi. Some infected calves have a degree of natural immunity that prevents development of lesions; however, they can be a source of infection. Show calves are frequently infected from spore contaminated equipment that has not been properly cleaned.

Spores germinate and attack the shafts of the hair and the surface layers of the skin. Exudate oozes from the damaged skin and mixes with debris from skin and hair, thereby forming a crusty scab. The scab is grey-white and noticeably higher than the surrounding skin. Infection spreads from the center outwards and results in the circular lesion 1 to 1.5 inches in diameter. Adjacent lesions may overlap and create larger infected areas. Lesions are most frequent on the head and neck, but they may be found over the entire body in severe cases. Scabs may fall from older lesions and leave a hairless area in the center, one that has a ring of exudate at the edge. Hence, the name ringworm.

Topical treatment, application of the medication directly onto the lesion, is the usual procedure. Medication cannot penetrate the crusts; the crusts should be removed by scraping or brushing. They should be collected and burned to avoid contaminating the premises. Lesions should be treated at least twice, three to five days apart. Iodine is the most common solution used for topical treatment, but the prolonged treatment and expense of the drug make it impractical in all but valuable animals.

Enhanced Alkaline Water boosted with e.g. Sodium Hydroxide and Sodium Bicarbonate can be formulated a non-flammable, non-toxic, easy to use topical spray with excellent fungicidal properties. An indication dye may be added to the formulation to give the product staining power. Enhanced Alkaline Water is appropriate for many bacterial and fungal livestock diseases such as hairy ringworm. With this disease and other skin or fungicidal diseases, the Enhanced Alkaline Water can be applied by sprayer or dipping or mopping on the target or infected area.

Use of Enhanced Alkaline Water as a Fogging Medium with poultry incubators replacing formaldehyde. In poultry incubators, eggs of different ages are often set and each setting transferred to a separate unit prior to hatching. Separate hatching units permit proper sanitation and disease control measures to be practiced between batches of chicks. A common procedure is to clean and disinfect the incubator and hatcher before each usage whereas all egg shells, down, dust, and extra material is removed with a vacuum before washing the unit with a warm detergent solution and finally rinsed with a disinfectant solution. When dry, the unit is switched on and brings to proper temperature and humidity conditions prior to filling with eggs.

Fumigation is another tool for disease control and is something good to turn to when either the cleaning is poor, eggs are dirty, or machines are filled with eggs and it is difficult to empty and clean properly. The current state of the art is to fog neat formalin (39% formaldehyde) into the incubator. Formaldehyde has been proven to be hazardous and a safety hazard to the hatchery employees. The fumigation process is also very corrosive to the incubator.

Enhanced Alkaline Water does not lose its efficacy when misted or atomized. This enables Enhanced Alkaline Water to be an appropriate medium to fog into a poultry incubator. Fogging a sanitizer or disinfectant into the incubator is a critical HAACP control. If several eggs burst during incubation, it greatly increases the risk of salmonella contamination to every egg in incubator.

Using Enhanced Alkaline Water to replace formaldehyde is an appropriate application. It can be used exactly like formaldehyde with the same fogging cycles and duration.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A stable electrochemically generated solution or hydrogel formulation thereof having Sodium Hydroxide as active ingredient, a pH of between 11 and 13, an oxidation-reduction potential (ORP) of between −400 to −800 millivolts whereas the solution or hydrogel formulation has an extremely strong hypertonic effect giving Enhanced Alkaline Water antimicrobial, bactericidal and fungicidal properties enabling to use it as a sanitizing and/or disinfecting solution.

2. The solution or formulation of claim 1, wherein Enhanced Alkaline Water is electrochemically generated by electrolysis of a dilute saline solution utilizing one or more cylindrical electrolysis cells comprised of an outer cylindrical electrode separated from an inner cylindrical electrode by a cylindrical ion-selective membrane arranged coaxially one within the other to create a cathode chamber and an anode chamber; a pair of end pieces to each of said cells where a space between said inner cylindrical electrode and said cylindrical ion-selective membrane and a space between the ion-selective membrane and the outer cylindrical electrode defines anode and cathode chambers; wherein one of said electrodes functions as an anode and the other electrode functions as a cathode to generate three different antimicrobial solutions utilizing different volumes and flow-patterns, applying different voltage and current on the electrolysis cells as well varying the conductivity of the diluted brine solution pumped through said electrolysis cells.

3. The method of claim 2, wherein a saturated brine solution is prepared in a brine tank wherein purified granular Sodium Chloride is saturated in purified softened or reverse osmoses water by means of gravity and wherein the saturated brine solution is pumped from the bottom of the brine tank and diluted with purified softened water or reverse osmoses water to obtain a dilute saline solution for electrolysis with a predetermined conductivity

4. The solution or formulation of claim 1, wherein Enhanced Alkaline Water consist of about 150 to 200 ppm Sodium Hydroxide, has an alkalinity of about 1000 to 2000 ppm and is stable for at least 12 months.

5. The solution or formulation of claim 1, wherein Enhanced Alkaline Water has antioxidant properties; it has a negative ORP protecting metal from rusting and corrosion when applied on a metal surface.

6. The solution or formulation of claim 1, wherein Enhanced Alkaline Water is formulated as a clear liquid, gel, cream, paste or foam and wherein additives are used to formulate a variety of products with any loss of stability or efficacy against fungi, bacteria and microorganism.

7. The method of claim 6, wherein the additives such as gelling agents, dyes, fragrances, foaming agents, biocides, biopesticides may be mixed with Enhanced Electrolyzed Water to give Enhanced Alkaline Water specific antimicrobial, bactericidal, fungicidal, cleaning, drying, foaming, odor and/or visual properties.

8. The products of claim 6, wherein Enhanced Alkaline Water has strong hypertonic properties making it an excellent fungicide against e.g. Microsporum and Trichophyton and an powerful bactericide against different types of bacteria such as Escheria coli, Salmonella typhi, Staphylococcus aureaus, Pseudomonas aeruginosa and Candida albicans.

9. The solution or formulation of claim 1, wherein Enhanced Alkaline Water uses hydroxyl ion (OH—) chemistry that produces a surfactancy and self-assembly properties enabling the solution to quickly attract dirt, lift it from its substance and cluster the dirt particles for easy removal.

10. The solution or formulation of claim 1, wherein Enhanced Alkaline Water can be used to clean and sanitize all hard surfaces.

11. The method of claim 10, wherein a hard surface is cleaned and sanitized by applying the solution of claim 1 to the hard surface by means of fogging, (electrostatic) spraying, pouring, dipping or mopping.

12. Method of claim 10, wherein Enhanced Alkaline Water can be fogged in any type of atomizing equipment, wherein the micro-droplet will not loss stability of efficacy and whereas a fog made with the solution of claim 1 can replace formaldehyde usage in hatcheries or other enclosed whereas high level of sanitation is required.

13. The method of claim 10, wherein Enhanced Alkaline Water can be used on many surfaces and causes no chemical reactions and does not cause substances such as glass, mirrors, painted surfaces, wood, plastics and rubber to deteriorate.

14. The solution or formulation of claim 1, wherein Enhanced Alkaline Water can be used in the vicinity of people with allergies, babies, elderly people and whereas it can be safely applied on the skin and hands of humans and animals.

15. The solution of formulation of claim 1, wherein Enhanced Alkaline Water is 100% biodegradable, non-toxic, non-hazardous, non-corrosive, non-flammable and non-explosive.

16. A method of cleaning and sanitizing incubators by applying the solution of claim 1 directly on the surface.

17. A method of sanitizing hands and tissue by applying the solution or hydrogel formulation of claim 1 directly on the skin.

18. A method of cleaning, sanitizing and drying the umbilical cord by applying the product of claim 6 directly on the umbilical cord.

19. A method of cleaning, preventing and eradication fungal livestock diseases such as dermatophytosis by applying the product of claim 6 directly on the target or infected area.

20. A method of cleaning, preventing and eradication bacterial diseases such as Papillomatous Digital Dermatitis by applying the product of claim 6 directly on the target or infected area.
